(19) United States
(12) Patent Application Publication
(10) Pub. No.: US 2008/0001778 A1
(43) Pub. Date: Jan. 3, 2008

(54) System and Method for Verifying the Identity of a Remote Meter Transmitting Utility Usage Data

(75) Inventors: David C. Challener, Raleigh, NC (US); Kenneth D. Timmons, Raleigh, NC (US)

Correspondence Address: Ronald V. Davidge, Suite 219, 9900 Stirling Road, Cooper City, FL, 33026, US

(73) Assignee: INTERNATIONAL BUSINESS MACHINES CORPORATION, Armonk, NY (US)

(21) Appl. No.: 11/829,931

(22) Filed: Jul. 29, 2007

Related U.S. Application Data
(62) Division of application No. 10/637,889, filed on Aug. 8, 2003.

(51) Int. Cl. G08B 23/00

(52) U.S. Cl. 340/870.02

(57) ABSTRACT

In a central system for receiving reports of utility usage from a number of remote meters, a provision is made for assuring that a received report has actually been transmitted from a meter that has been registered with the central system. During the registration process, the meter transmits its public cryptographic code to the central system. With each report of utility usage, the meter sends a version of a message encrypted with its private cryptographic key. The central system decrypts this message with the meter's public key. If it matches an unencrypted version of the message it is known that the meter sent the report. The unencrypted message may be generated by the central system and transmitted to the meter in a request for a report, or it may be generated by the meter and sent along with the encrypted version.

### CROSS-REFERENCE TO A RELATED APPLICATION

This application is a division of a co-pending U.S. application Ser. No. 10/637,889, filed Aug. 8, 2003.

### BACKGROUND OF THE INVENTION

1. Field of the Invention

This invention relates to a system in which a number of remote meters transmit data to a central computing system, indicating usage of the product of a utility, and, more particularly, to for verifying the identity of such meters as the data is received.

2. Summary of the Background Art

Usage by individual customers of a non-telephone utility product, such as electrical energy, gas, or water, has traditionally been measured by meter readers visiting the locations of the customers on a periodic basis to read utility meters located at the points where the product is consumed by being transferred to the individual customers. Because of the substantial costs of this traditional approach, and additionally because of the likelihood of errors occurring during the collection of such massive amounts of data at widespread locations, a number of methods have been developed for automating the process of collecting data from remote meters. For use with such methods, the individual point of consumption meter must be of a machine readable type, having a Hall effect device or an encoder producing a signal indicating the angle of rotation of a rotor driven in response to the usage of the utility product, such as water, gas, or electrical power, measured by the meter.

For some of these methods, the individual meters are provided with an ability to transmit radio messages over short ranges, with the messages including data indicating the measured usage of the utility product. These short-range radio transmissions are then received and recorded by a radio-equipped vehicle traveling around the area served by the utility on a periodic basis.

Other methods for automating meter reading use communication networks between large numbers of individual meters and AMR (Automated Meter Reading) systems that read data transmitted from the meters on an automatic or periodic basis. A number of different types of transmission networks are used to provide for communication between the meters and the AMR system. For example, an RF (radio frequency) network may be used, with the meters being provided with radio transmitters and the AMR system each being connected to a central receiving station having an antenna. Alternately, communication may occur through the public switched telephone network, to which both the meter and the AMR system are connected through modems or through IEEE-1390 interfaces. The meter may be connected to the telephone network through the phone line of the utility customer, whether an individual or organization. Alternatively, the data describing the output of an electric meter may be transmitted over the power lines themselves using a method known as a PLC (power line carrier).

The transmission of product usage data may be, for example, a one-way radio communication from a meter to the AMR system or a two-way telephone communication initiated by a call from the AMR system to the meter, with the meter responding with the data. If this type of two-way conversation is established in response to a call by the AMR system over the telephone line of the utility customer, arrangements may be made for placing the call at a particular time of day and for preventing the ringing of telephone equipment other than the modem connected to the meter during this time period.

A number of patents describe methods and components to be used to form a network of utility meters reporting to an AMR system. For example, U.S. Pat. No. 6,208,266 describes a remote data acquisition and processing system. One embodiment of the system of the present invention for use in monitoring utility operation includes at least one optical imaging device for generating computer readable image data of a visual representation, generated by a utility meter, of utility operation-related data. A host processor, which is remotely located from the optical imaging device and the utility meter, is also provided in this embodiment of the present invention for generating the utility operation-related data from the image data and for storing the image data. In another such example, U.S. Pat. No. 5,897,607 describes a method and apparatus for measuring use of a commodity and for transmitting the measurement over a global computer information network to a remote location. The apparatus comprises a data acquisition and reporting device and an automatic meter reading device operatively arranged to measure use of a commodity and transmit the measurement over a global information network to the data acquisition and reporting device. In yet another such example, U.S. Pat. No. 6,073,169 describes an AMR system including a host server interfaced to a plurality of nodes where each node communicates with a number of utility meters. The system selects a group of noninterfering nodes and, uses an RIF broadcast from the host server to initiate the reading of meters and the uploading of meter data provided by those meters to the nodes and, ultimately, to the host server. The system also has a number of gateways that communicate with a plurality of nodes, grouped to form sets of noninterfering gateways. In this embodiment, the system selects a set of noninterfering gateways and uses an RIF broadcast from the host server to initiate the reading of meters and the uploading of meter data provided by those meters to the nodes and, ultimately, through the gateways to the host server. A method for using an outbound RIF network to automatically read meters is also provided.

A number of patents describe methods for handling the information collected by an AMR system. For example, U.S. Pat. No. 6,163,602 describes a system and method providing a conversion and interface between automated meter reading systems and telephone billing systems to enable a telephone billing system to collect, process, and combine usage data of telephone and non-telephone services and products, such as water usage, natural gas consumption, electric power consumption, and long distance and toll call usage. In another such example, U.S. Pat. No. 6,088,659 describes an automated meter reading (AMR) server having an open, distributed architecture that collects, loads, and manages system-wide data collected from energy meters and routes the data automatically to upstream business systems. The AMR server includes a repository of metering data, and additionally provides timely access to information by including collection, storage, validation, estimation, editing, publishing and securing of meter consumption and interval data. The AMR server obtains data from meters equipped with modems via standard telephone lines or public RF networks. The data is converted from the format of the meter/communications infrastructure to a format usable by the AMR server and the repository. The data is converted from the AMR-compatible form to a format of a specific upstream business system prior to transmission. The data may also be validated in accordance with the upstream business system requirements. The AMR server provides for on-line users, interfacing with multiple dissimilar platforms and meter firmware, maintenance of system availability, data recovery, access to multiple legacy systems, and access by common set of Application Program Interfaces.

Unfortunately, the history of utility product usage measurement with point-of-consumption meters includes a number of examples of individual customers tampering with the meters to prevent the fair and accurate reporting of such usage. Therefore, a number of patents describe ways to prevent or detect such tampering. For example, U.S. Pat. No. 6,232,886 describes a method and apparatus facilitate improved sensing of tampering of an electrically powered device, such-as an electric watt-hour meter installed at a residence for metering the amount of electric energy consumed at the residence. The detected tampering involves an effort to remove the electric meter from its power socket, to interrupt the metering of electric energy consumption, or to otherwise gain access for diverting electric energy. Removal of the electric meter from its power socket interrupts power to the meter. The method and apparatus senses motion of the meter and sets a “Tamper Flag” in a non-volatile memory. The “Tamper Flag” is saved i.e., is not cleared from the non-volatile memory) if loss of power to the meter occurs within a predetermined period of time. The “Tamper Flag” is cleared if there is no loss of power to the meter within the predetermined period of time. Upon detecting a resumption of power after a loss of power to the meter, an indication of sensed tampering is made if the “Tamper Flag” is set. In another such example, U.S. Pat. No. 6,118,269 describes An electric meter tamper detection system for sensing removal of an electric meter from a corresponding meter socket and for generating a tamper signal is disclosed. In this system, the tamper signal is relayed to a headend when the electric meter—connected in series with and monitoring current flow through at least one conductor—has been removed from the meter socket. At least one resistor is electrically connected to the line-side of the conductor. A light emitting diode is electrically coupled to the resistor and to the load-side of the conductor. A transistor receives the tamper signal from the light emitting diode when the electric meter is removed from the meter socket. A microprocessor is coupled to the transistor, receives the tamper signal from the transistor, and relays the tamper signal to said headend. Thus, the headend is immediately notified if and when the electric meter is removed from its meter socket. A modular meter based utility gateway enclosure which resides between a power meter and a meter socket of a residence or other building supports multiple interchangeable local area network (LAN) and wide area network (WAN) interface cards is also disclosed.

Unfortunately, it is possible, with a system including a meter reporting data to a remote computing system, to disable the meter so that it does not transmit or to otherwise block the network or channel by which the meter is to communicate with the remote computing system. Then, it is further possible to generate a false communication giving a false, and presumably lower, report of utility usage, which is mistaken by the computer system for the actual report. What is needed is a method and system for preventing this way of fraudulently avoiding payment for actual utility usage.

### SUMMARY OF THE INVENTION

Accordingly, it is an objective to the invention to provide a system, including a number of remotely located meters reporting utility usage data to a central computer system can reliably determine whether a report of utility usage actually is being made by the meter installed for that purpose.

In accordance with an aspect of the invention, a system is provided for receiving data regarding usage of a utility product at a plurality of remote locations. The system includes a central computer system, a database accessed by the computer system, a plurality of meters, and a communication network connecting each meter within the plurality of meters with the central computer system to transmit data to the central computer system. The database stores a plurality of data records. Each data record in the plurality of data records includes a meter identifier identifying a meter within the plurality of meters associated with the data record and a public cryptographic key of the meter. Each of the meters includes data storage storing a private cryptographic key of the meter and a microprocessor accessing the data storage and programmed to encrypt a message with the private cryptographic key and to transmit the message encrypted with the private cryptographic key over the communication network to the central computer system. The message includes an alphanumeric value, together with a value representing a measured usage of the utility product. Information encrypted with the private cryptographic key is decrypted with the public cryptographic key. The central computer system includes a processor programmed to receive the message encrypted with the private cryptographic key, to decrypt, with the public cryptographic key of the meter, the message encrypted with the private cryptographic key, forming a decrypted message, and to compare the alphanumeric value within the decrypted message with an unencrypted version of the alphanumeric value.

In accordance with a first embodiment of the invention, the communication network provides for two-way communications between each of the meters and the central system. A call to receive a report on meter usage is initiated by the central system, which generates a random value to be transmitted to the meter for encryption. The central system also stores the random value for comparison with a decrypted version of the encrypted alphanumeric value it will receive from the meter. If these alphanumeric values match, it is known that data has been received from the meter itself, since there is no other way to encrypt the random alphanumeric value so that it will be successfully decrypted with the public key of the meter.

In accordance with a second embodiment of the invention, the communication network provides for one-way communications from each of the meters to the central computer system. A call to report utility usage is initiated by the meter, which transmits a alphanumeric value from a predetermined alphanumeric value sequence in both an unencrypted form and in a form as a part of the encrypted message. If the central computer system then determines that the version of the alphanumeric value from the encrypted message, as decrypted using the public key of the meter, matches the unencrypted version of the alphanumeric value, a further determination is made of whether the alphanumeric value follows a alphanumeric value previously received from the same meter in the predetermined sequence. If it does, the new alphanumeric value is stored for subsequent use in verifying another transmission, along with the utility usage data reported by the meter. This method ensures that each alphanumeric value encrypted and transmitted by a particular meter is a new alphanumeric value, that has not been encrypted and transmitted before, so that it is impossible to form a false transmission that will be accepted by the central system by using a previously recorded version of a alphanumeric value from the meter in its encrypted and unencrypted forms.

In accordance with another aspect of the invention, a method is provided for transmitting data regarding usage of a utility product to a remote location and for storing the data in the remote location. The method includes:
a) generating the data within a meter in response to usage of the utility product;
b) storing the data within the meter;
c) encrypting a message with a private cryptographic key stored within the meter, with the message including an alphanumeric value and utility usage data derived from the data stored within the meter;
d) transmitting the message encrypted with the private cryptographic key over a communication network to a remote central computer system;
e) decrypting the message encrypted with the private cryptographic key within the remote central computer using a public cryptographic key of the meter stored within a database accessed by the remote central computer, wherein the public cryptographic key decrypts a message encrypted with the private cryptographic key; and
f) comparing the alphanumeric value from message decrypted in step e) with an unencrypted version of the alphanumeric value.

Preferably, step a) of this method is preceded by a process of registering the meter with the central computer. This registration process includes:

transmitting the public cryptographic key of the meter, along with an identifier of the meter, from the meter to the central computer over the communication network; and

writing the identifier of the meter and the public cryptographic key of the meter within a data record in the database accessed by the central computer.

In accordance with a first embodiment of the invention, step a) is preceded by the following steps:

generating a random value in the central computer and storing the random alphanumeric value as the unencrypted version of the message;

initiating a call over the communication network from the central computer to the meter; and

transmitting the random value as the alphanumeric value over the communication network from the central computer to the meter.

Also in accordance with the first embodiment, step e) is followed by storing the utility usage data transmitted from the meter in step d) in response to a determination in step f) that the alphanumeric value from the message decrypted in step e) matches the unencrypted version of the alphanumeric value.

In accordance with a second embodiment of the invention, step a) is preceded by the following steps

generating and storing an alphanumeric value to be encrypted as the message within a predetermined sequence of alphanumeric values in the meter, and

initiating a call over the communication network from the meter to the central computer,

Additionally in accordance with the second embodiment, in step d), the alphanumeric value is additionally transmitted in an unencrypted form, along with the message encrypted with the private cryptographic key, and step f) is followed by following steps:

determining in the central computer system whether the alphanumeric value additionally transmitted in an unencrypted form in step d) follows a alphanumeric value additionally transmitted by the meter in the predetermined sequence of alphanumeric values, and

storing the utility usage data transmitted from the meter in step d) in response to a determination in step f) that the alphanumeric value from the message decrypted in step e) matches the unencrypted version of the message together with a determination that the alphanumeric value additionally transmitted in an unencrypted form in step d) follows a alphanumeric value additionally transmitted by the meter in the predetermined sequence of alphanumeric values.

### BRIEF DESCRIPTION OF THE DRAWINGS

FIG. 1 is a block diagram of a system configured for remote transmission of utility product usage data in accordance with the invention;

FIG. 2 is block diagram of a version of a communications adapter within a meter within the system of FIG.1;

FIG. 3 is a flow chart of processes occurring within a meter of FIG. 1 as the meter is registered with an AMR system therein in accordance with a first embodiment of the invention;

FIG. 4 is a flow chart of processes occurring within the AMR system of FIG. 1 as the meter therein is registered with the AMR system in accordance with the first embodiment of the invention;

FIG. 5 is a flow chart of processes occurring within the meter of FIG. 1 following the registration process of FIG. 3 in accordance with the first embodiment of the invention;

FIG. 6 is a flow chart of processes occurring within the AMR system of FIG. 1 during a process of reporting utility usage from the meter therein in accordance with the first embodiment of the invention;

FIG. 7 is a flow chart of processes occurring within the meter of FIG. 1 in accordance with a second embodiment of the invention;

FIG. 8 is a flow chart of processes occurring within the AMR system of FIG. 1 in accordance with the second embodiment of the invention; and

FIG. 9 is a block diagram of a system configured to provide for registration of meters with an AMR system in accordance with a third embodiment of the invention.

### DETAILED DESCRIPTION OF THE INVENTION

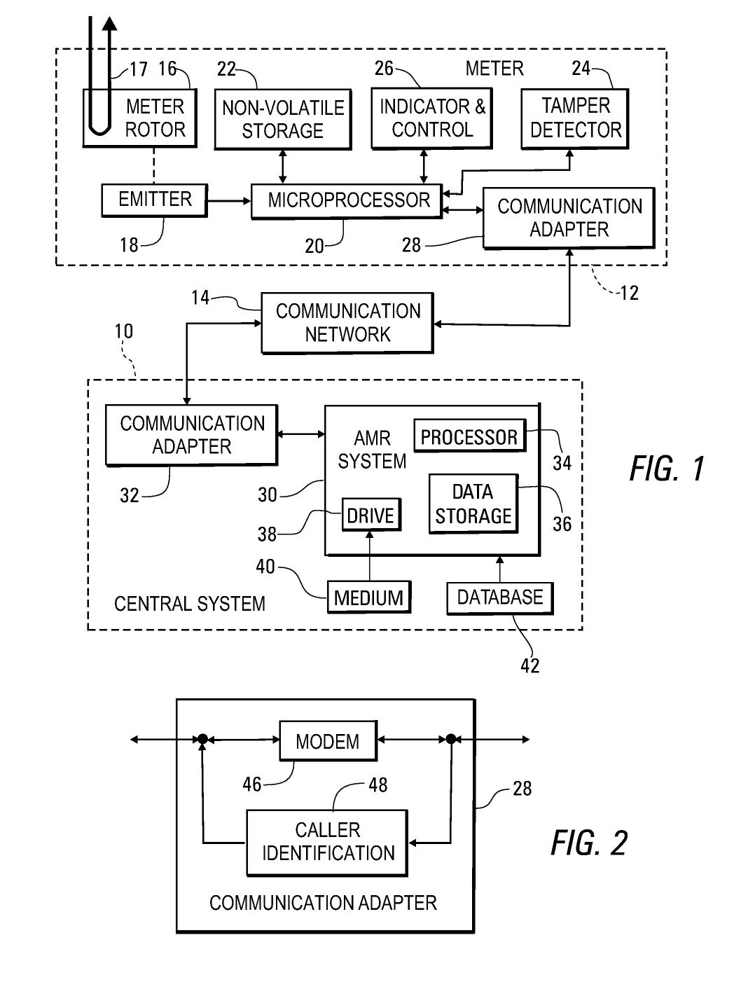

FIG. 1 is a block diagram of a system configured for remote transmission of utility product usage data in accordance with the invention. The main components are a central system 10 configured to receive the data, a meter 12 configured to provide the data, and a communication network 14 across which the data is transmitted.

The meter 12 is of a type generating computer readable information at the point of consumption of the utility product. The meter 12 includes a meter rotor 16, mechanically turned by the usage of the utility product flowing through the meter 12 along a path 17. For example, the rotor 12 may be a rotor in a wattmeter measuring the usage of electrical energy, or a rotor driven by the passage of water or gas through the meter to be consumed by the customer. The meter rotor 16 mechanically rotates an emitter 18, which may be a Hall-effect device or an optical device, producing pulses with rotation. The meter 12 further includes a microprocessor 20 receiving pulses from the emitter 18 as a digital input representing the usage of the utility product. Additionally within the meter 12, non-volatile storage 22 stores data and instructions for routines to be executed within the microprocessor 20. Preferably, the meter 12 also includes a tamper detector circuit 24 providing an indication to the microprocessor 24 when tampering occurs, such as an attempt to open the enclosure of the meter 12, or such as the disconnection of the meter from the path 17 through which the product flows.

Preferably, the meter 12 further includes an indicator and control, which may be as simple as a button to start an operation and a light-emitting diode (LED) turning green to indicate the successful completion of an operation or red to indicate its failure. Since the physical manipulation of the meter 12 is probably limited to actions of a trained installer or service person, a special tool or key may be required to actuate the button. Alternately, the indicator and control function may be provided through a separate device carried by the installer or service person and temporarily plugged into the meter 12.

The meter 12 is connected to the communication network 10 through a communication adapter 28, the nature of which is determined by the nature of the communication network 14. For example, the communication network may comprise the public switched telephone network, with the communications adapter 28 being a modem.

Similarly, the central system 10 includes an AMR (automated meter reading) computer system 30 connected to the communication network 14 through a communication adapter 32. The AMR system 30 includes a processor 34, data storage 36 forming a computer readable medium and a drive unit a drive unit 38 reading a removable medium 40, such as a magnetic diskette or an optical disk. Computer programs for execution within the processor 34 are entered into the AMR system 30 through the removable medium 40 in the form of computer readable instructions or through the communication adapter 32 in the form of a modulated carrier wave. Such computer programs are stored in data storage 36. The AMR system 30 is also provided with access to a database 42, which stores data used to contact individual meters 12, and which additionally stores utility usage data transmitted from individual meters 12.

While FIG. 1 shows only a single meter 12 connected to the AMR system 30, it is understand a practical system will include thousands of meters 12 connected to a single AMR system 30, often through the use of several different types of communication networks, with the type of communication network for a particular area being determined by the density of customers in the area and by factors such as the type of utility usage.

According to the invention, the meter 10 registers with the AMR system 30 to begin a process in which the meter 10 periodically transmits data reflecting usage of the utility product to the AMR system 30. According to a first embodiment of the invention, the communication network 14 carries data in both directions, and each communication following the registration process is initiated by the AMR system 30. Such a two-way communication network is readily formed, for example, by including the public switched telephone network. According to a second embodiment of the invention, the communication network 74 carries data only from the meter 12 to the AMR system 30. Such a one-way communication network is readily formed, for example, by providing the meter 12 with an RF transmitter and an antenna, and by providing the central system 10 with a radio receiver and antenna receiving signals from a number of meters 12.

It is understood that the communication network 14, forming a part of a system operating according to the invention, may include various types of networks well known to those skilled in the art of building networks for data transmission. For example, two-way radio communications are established at some cost in complexity over wireless LANs (local area networks). Data transmissions may be routed from telephone lines over the Internet, with communications being established between the AMR system 30 and meters 12 dispersed over a wide geographic area.

Preferably, a process is implemented within the meter 12 for identifying a caller placing a call over the communication network 14 to the meter. FIG. 2 is a block diagram of a particular type of communication adapter 28, with a modem 46 being provided for use with a telephone line according to the first embodiment of the invention. The communications adapter 28 also includes a caller identification circuit 48 that is, for example, a conventional circuit used to identify a caller within a currently available telephone system. Alternately, a code identifying the ARB system 30, sent as part of a call initiated by the AMR system 30 may be used to identify the system 30 as the caller.

In accordance with the present invention, the meter 12 is registered with the AMR system 30 in a process that is part of the installation of the meter 12 to measure usage of a utility product at a particular point. During the registration process, a data record within the database 42 is established to be associated with the particular meter 12, with the data record storing usage data reported by the meter 12. In accordance with the first embodiment of the invention, the communication network 14 is a two-way network, with the process of communicating usage data being initiated by a call from the AMR system 30 to the meter 12, with the meter 12 responding with usage data, and with the AMR system 30 verifying that the response has indeed been from the meter 12.

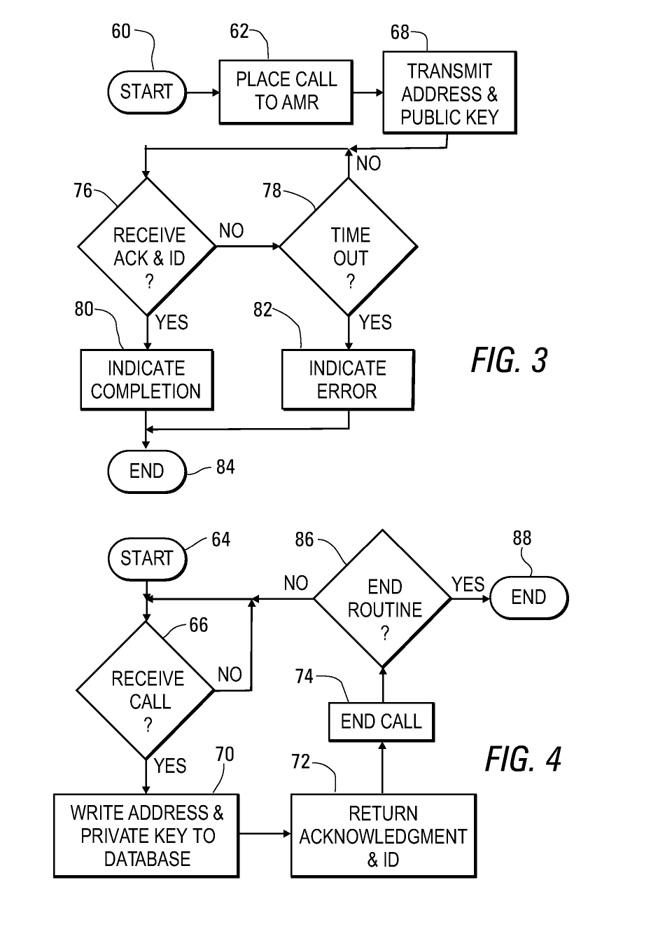

Operation of the system of FIG. 1 in accordance with the first embodiment of the invention during the registration process will now be discussed, with particular reference being made to FIGS. 3 and 4. FIG. 3 is a flow chart of process steps occurring within the meter 10 during this process, under control of a program executing within the microprocessor 20, while FIG. 4 is a flow chart of process steps occurring within the AMR system 30 during this process, under control of a routine executing within the processor 34.

Referring first to FIGS. 1 and 3, the process of registering the meter 12 with the AMR system 30 is begun in step 60 by a technician installing the meter 12, using the indicator and control 26 of the meter 12. Because of the simplistic nature of the registration process, and because of the automatic nature of operation of the meter 12 following this process, the indicator and controls 26 may be rudimentary, consisting of a pushbutton used to start the process and an LED providing a green indication that the process has been completed successfully or a red indication that the process has failed. Next, in step 62, the meter 12 places a call to the AMR system 30 over the communication network 14.

Referring additionally to FIG. 4, after starting in step 64, a program executing in the processor 34 of the AMR system 30 waits in step 66 to receive a telephone call from a meter 12. After such a call is established, the meter 12 transmits its address and public cryptographic key in step 68. The address is the means to be used to reach the meter 12 over the communication network 14, while the public cryptographic key is a key that may be used to decrypt a message encrypted with a private cryptographic key stored within the non-volatile storage 22. For example, if the meter 12 is connected to the communications network 14 through a telephone modem as shown in FIG. 2, the address may be the telephone number through which the meter 12 can be reached. In some cases the address, such as a specification for a particular RF frequency and an access code, may be programmed into the meter 12 when it is manufactured. In other cases, the address may be provided as an input by the technician installing the meter 12, using a keyboard provided as a part of the indicator and control 26 of the meter 12, or through a keyboard connected to the meter 12.

Then, in step 70, the AMR system 30 writes the data transmitted in step 68 to a new record in the database 42. Then, in step 72, the AMR system 30 returns an acknowledgement to the meter 12, indicating that the process has been successfully completed and ends the call in step 74. The AMR system 30 may also send an identifier (ID) to be subsequently used to determine whether a call placed to the meter 12 has actually been sent by the AMR system 30. After transmitting data in step 68, the meter proceeds to step 76 to receive the acknowledgement from the AMR system 30. If this acknowledgement has not been received, the meter 12 proceeds to step 78 to determine if a time out period starting with the transmission of data in step 68 has expired. If it has not, the system returns to step 76. If a determination is made in step 76 that the acknowledgement has been received, the successful completion of the registration process is indicated in step 80, for example by turning on an LED to provide a green indication. If the time out is reached before the acknowledgement is received, as indicated in step 78, the failure of the registration process is indicated in step 82. In either case, after the indication has been given in step 80 or 82, the routine executing within the microprocessor 20 of the meter 20 ends in step 84.

The routine shown in FIG. 4 preferably runs nearly continuously, in a multi-tasking environment on the AMR system 30, so that a meter 12 can call in to register with the system 30 at any time. However, a process step 86 for ending the routine is provided following the ending of a call in step 74 to allow the AMR system 30 to be shut down for maintenance or to add features. Thus, if a determination is made in step 86 that the routine is to be ended, it is ended in step 88. Otherwise, the AMR system 30 returns to step 66 to wait for the next call from a meter 14 to register.

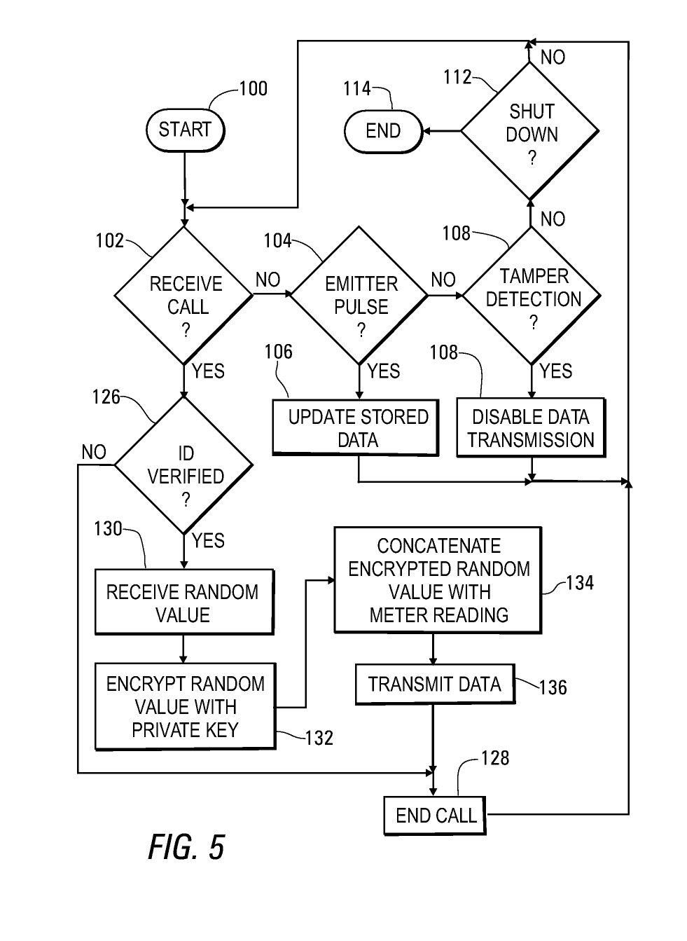

FIG. 5 is a flow chart of processes occurring within the meter 12 under control of a routine executing within the microprocessor 20, in accordance with the first embodiment of the invention, following the registration process explained above in reference to FIGS. 1, 3 and 4.

Referring to FIGS. 1 and 5, after completion of the registration process, a meter operation routine is started in step 100. The meter 12 then enters a loop to monitor events that can be expected to occur. In step 102, a determination is made of whether a call has been received through the communication network 14. If it has not, the meter 12 proceeds to step 104, in which a determination is made of whether a pulse from the emitter 18 has occurred, indicating a level of usage of the utility product. If it has, data stored within non-volatile storage 22 is updated in step 106 to reflect this usage. If it is determined in step 104 that an emitter pulse has not occurred, the meter 12 proceeds to step 108, in which the tamper detector 24 is examined to determine if tampering has occurred. If it has, the process of subsequent data transmission is disabled in step 110. For example, this process may be disabled by erasing a private key stored in non-volatile storage 22, so that the meter can no longer verify its identity when it reports the utility usage to the AMR system 30. Preferably, an operation by a technician is always required to restore the meter 12 to normal operation after data transmission is disabled in step 110.

Preferably, the routine of FIG. 5 operates continuously for a long period, until it is necessary to shut the meter 12 down for repair or modification. If a shut down is detected in step 112, the routine ends in step 114. Otherwise, the meter 12 returns to step 102 to repeat the monitoring process. The meter 12 also returns to step 102 following the storage of data in step 106 or following disabling data transmission in step 110.

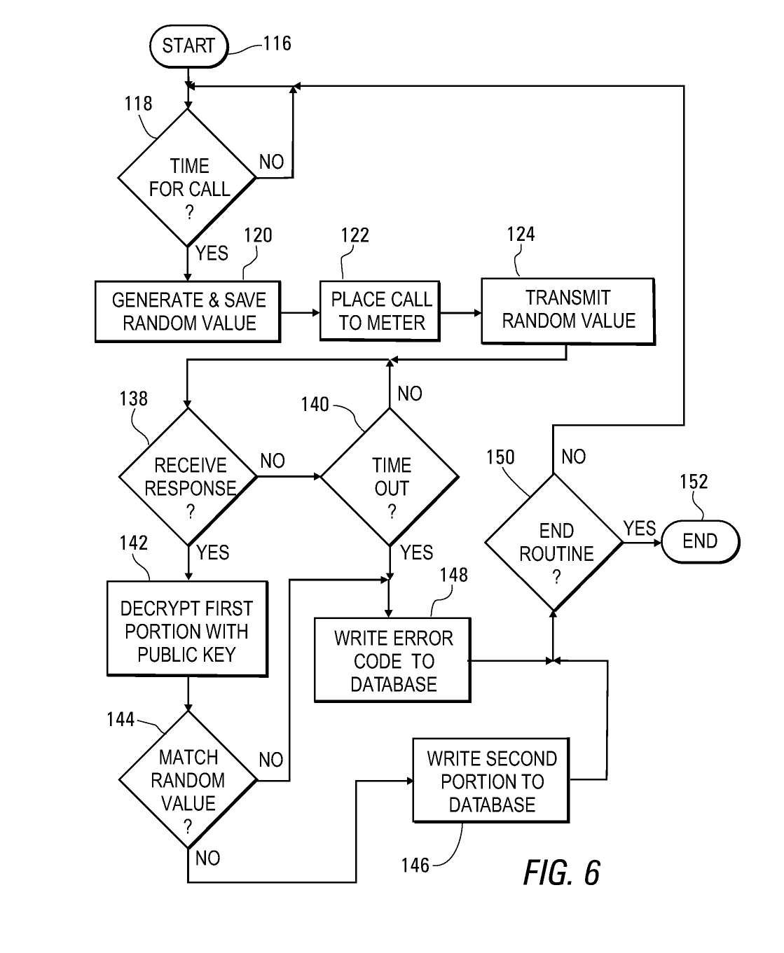

Operation of the system of FIG. 1 in accordance with the first embodiment of the invention during the process or periodically reporting utility usage will now be discussed, with continued reference being made to FIGS. 1 and 5, and with additional reference being made to FIG. 6.

FIG. 6 is a flow chart of process steps occurring within the AMR system 30 while polling various meters 12 communicating with the system 30, under control of a routine executing within the processor 34. After this routine is started in step 115, the system 30 waits in step 118 for a determination that a time has been reached to call one of the meters 12. The AMR system 30 is in communication with a large number of meters 12, which are polled on a periodic basis to determine the usage of a utility product. When it is determined in step 118 that the time to call a meter 12 has been reached, the system 30 proceeds to step 120, in which a random alphanumeric value is generated and saved. Then, in step 122, the system 30 places a call to the meter 12. Next, in step 124, the system 30 transmits the random alphanumeric value saved in step 120.

When the meter 12 determines in step 102 that a call has been received, it proceeds to determine, in step 126 whether the call has been placed by the AMR system 30 by verifying an identifier associated with the call through comparison with the identifier received during the registration process in step 76, described above in reference to FIG. 3. For example, if the call is made over a telephone line to the meter 12, and if the meter is equipped with a communication adapter 28 as described above in reference to FIG. 2, the caller identification circuit 48 may be used to perform this verification process. Alternately, the identifier may be transmitted from the AMR system 30 along with the random alphanumeric value in step 124 and compared within the meter 12 with data stored within non-volatile storage 22. In either case, if the identifier is not verified in step 126, the meter 12 ends the call in step 128 and returns to step 102 to wait for the next call. If the identifier is verified in step 126, the meter 12 receives, in step 130, the random alphanumeric value transmitted from the AMR system 30 in step 124. Then, in step 132, the meter 12 concatenates this random alphanumeric value with usage data read from non-volatile storage 22 to indicate usage of the utility product. Next, in step 134, the meter 12 encrypts this concatenated data with its private cryptographic key, which is also stored within non-volatile storage 22. Then, in step 136, this data is transmitted to the AMR system 30, and the call is terminated in step 128, with the meter 12 returning to step 102. This process encrypts both the random number and the usage data, to prevent the surreptitious attachment of a false version of the usage data, presumably indicating a lower level of usage, to the encrypted random number.

After transmitting the random alphanumeric value in step 124, the AMR system 30 proceeds to step 138 to determine if a response has been received from the meter 12. If it has not, the system 30 proceeds to step 140 to determine if a time out condition has expired. If it has not, the system 30 returns to step 138. If a response is received, as determined in step 138, before the time out condition is met, the system 30 proceeds to step 142 to determine whether the response has indeed been received from the meter 12. In this process, the response is decrypted using the public key of the meter 12, which is read from the database 42. If it is then determined in step 144 that the portion of the decrypted response corresponding to the random value matches the random alphanumeric value, which has been previously saved in step 120, it is known that the random alphanumeric value has been encrypted using the private key of the meter 12, which is stored only within the non-volatile storage 22 of the meter 12. Therefore, if it is determined in step 144 that these results match the random alphanumeric value, the response received in step 138 must be from the meter 12, so the portion of the decrypted value received in the response, which indicates utility product usage as reported by the meter 12, is written to the database 42 in step 146 to provide a record of such usage.

On the other hand, if it is determined in step 144 that this portion of the response, having been decrypted using the public key of the meter 12, does not match the random alphanumeric value, or if it is determined in step 140 that a time out condition is reached before a response is received, it is known that a response was not received from the meter 12, or, at least, that the meter 12 is not functioning properly. Therefore, in step 148, an error code is written to the database 42 in the data record corresponding to the meter 12.

After data is written to the database 42 in step 146 or 148, a determination is made in step 150 of whether the routine if FIG. 6 is to continue running. In general, this routine will be run for a long period, with many meters 12 being contacted to report product usage data. If the system is to be shut down for modification, or if a time period for the collection of such data is over, the execution of this routine is ended in step 152. Otherwise, the system 30 returns to step 118 to wait for the time to begin the next call to a meter 12.

In accordance with a second embodiment of the invention, the communication network 14 is a one-way network providing for communication from the meter 12 to the AMR system 30, with such communication being established to register the meter 12 with the AMR system 30 and thereafter to periodically report on utility product usage. Since the AMR system 230 cannot transmit a random alphanumeric value to the meter 12 for encryption, the meter 12 generates a alphanumeric value within a predetermined sequence of alphanumeric values to be transmitted to the AMR system 30 in both an unencrypted form and in form encrypted with the private key of the meter 12. The AMR system then decrypts the encrypted version of the alphanumeric value and compares it with the unencrypted version. If the versions match, the AMR system 30 then compares the alphanumeric value with a alphanumeric value that has been received in a most recent previous transmission from the same meter 12. If the alphanumeric value from the present transmission follows the alphanumeric value from the previous transmission in the predetermined sequence, the alphanumeric value from the present transmission is stored, along with the utility product usage data transmitted by the meter 12.

The use of a alphanumeric value sequence in this way ensures that each encrypted version of the alphanumeric value accepted by the AMR system 30 has not been previously transmitted from the meter 12. Otherwise, if previously encrypted and transmitted alphanumeric values were accepted, it would be possible to surreptitiously record and later retransmit a alphanumeric value in both encrypted and unencrypted forms, along with a fraudulent meter reading.

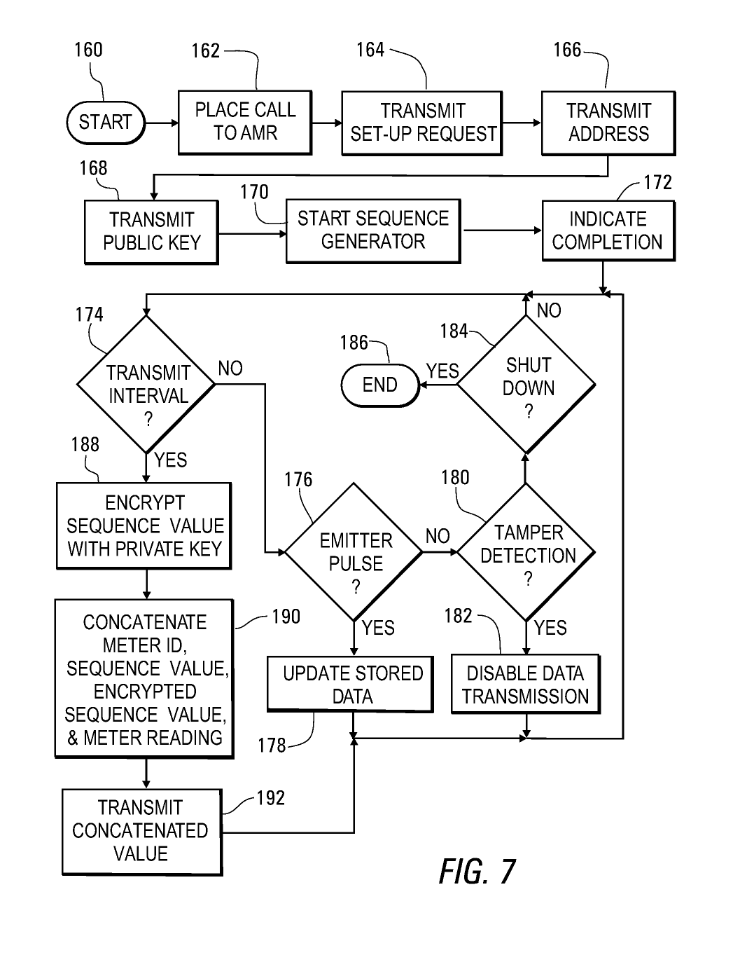

FIG. 7 is a flow chart of a process occurring within the meter 12 operating in accordance with the second embodiment of the invention. This process is started in step 160 by the technician installing the meter 12. First, in step 162, the meter calls the AMR system 30 to begin the registration process. Then, in step 164, the meter 12 transmits a code indicating that the call is a request for registration, or set-up, with the AMR system 30. Next, in step 166, the meter 12 transmits an identifier that can be associated with the particular customer to be billed for utility usage. Then, in step 168, the meter 12 transmits its public cryptographic key, which has been stored in non-volatile storage 22 during the process of manufacturing the meter 12.

Following the registration process, the verification of communications from the meter 12 is based on the encryption of a sequence of alphanumeric values that are encrypted using the private key of the meter 12. Therefore, in step 170, before completion of this process, a sequence generator is started. Each time a alphanumeric value is required from the sequence generator, which may be implemented in software or hardware, a next alphanumeric value from a predetermined sequence is provided. A non-limiting example of a sequence generator is an incrementing or decrementing counter. Then, in step 172, the meter 12 provides an indication to the technician installing the device that the registration process has been completed. Such an indication can be given by lighting an LED.

After completion of the registration process, a meter operation routine is started in step 174, with the meter 12 entering a loop to monitor events that can be expected to occur. First, in step 174, a determination is made of whether the time has arrived to transmit usage data to the AMR system 30. Such a transmission may be made on a periodic basis, at a particular time of day, or following a following a predetermined amount of product usage, as indicated by pulses from the emitter 18. If this time has not been reached, the meter 12 proceeds to step 176, in which a determination is made of whether a pulse from the emitter 18 has occurred, indicating a level of usage of the utility product. If it has, data stored within non-volatile storage 22 is updated in step 176 to reflect this usage. If it is determined in step 176 that an emitter pulse has not occurred, the meter 12 proceeds to step 180, in which the tamper detector 24 is examined to determine if tampering has occurred. If it has, the process of subsequent data transmission is disabled in step 182. For example, this process may be disabled by erasing a private key stored in non-volatile storage 22, so that the meter can no longer verify its identity when it reports the utility usage to the AMR system 30. Preferably, an operation by a technician is always required to restore the meter 12 to normal operation after data transmission is disabled in step 110.

Preferably, the routine of FIG. 7 operates continuously for a long period, until it is necessary to shut the meter 12 down for repair or modification. If a shut down is detected in step 184, the routine ends in step 156. Otherwise, the meter 12 returns to step 174 to repeat the monitoring process. The meter 12 also returns to step 174 following the storage of data in step 178 or following disabling data transmission in step 182.

If it is determined in step 174 that the time has arrived to transmit usage data to the AMR system 30, the meter 12 proceeds to step 188 in which A value supplied by the sequence generator started in step 179 is concatenated with a value read from non-volatile storage 22 to indicate utility usage. Next, in step 190, this concatenated value is encrypted with the private key of the meter 12. This private key has been stored in non-volatile storage 22 during the process of manufacturing the meter 12. Then, in step 192, the meter 12 concatenates its meter ID, which has previously been transmitted to the AMR system 30 in step 166, the sequence value from the sequence generator, in unencrypted form, and the encrypted value generated in step 190. Next, in step 193, this data is transmitted to the AMR system 30. When this transmission is complete, the meter 12 returns to step 174.

The transmission of the sequence generator value in both unencrypted and encrypted form provides the AMR system 30 with a way to verify that the data transmission is actually from the meter 12. Since only the meter 12 has access to its private key stored, stored in non volatile storage 22, since the AMR system 30 has access to the public key of the meter 12, which has been transmitted in step 168 to be stored within the database 42, the AMR system 30 can determine that the transmission was from the meter 12 by decrypting the encrypted sequence generator value with the public key to see if the decrypted value matches the sequence generator value that has not been encrypted.

A sequence generator value is used for this purpose instead of a random alphanumeric value to prevent the surreptitious generation of validation data by someone attempting to transmit false data from another source. In this regard, it is assumed that transmissions of data from the meter 12 can occur, and that someone monitoring such transmissions would be able to re-transmit validation data as part of a new, false communication. However, the use of sequence generator values assures that each alphanumeric value to be used in unencrypted and encrypted form is larger than the last (or smaller, if the sequence generator is of a decrementing type). Thus, the validation process requires that each such alphanumeric value follow one another. The alphanumeric values can be sequential numbers, such as 1, 2, 3, 4, . . . , with skipped values not being identified as a problem in the validation process, since they may be the legitimate result of failed transmissions. Preferably, the process of recording utility product usage is a cumulative process, such as the rotation of the mechanism of a wattmeter or water meter, so that failed transmissions will not result in a permanent loss of usage data.

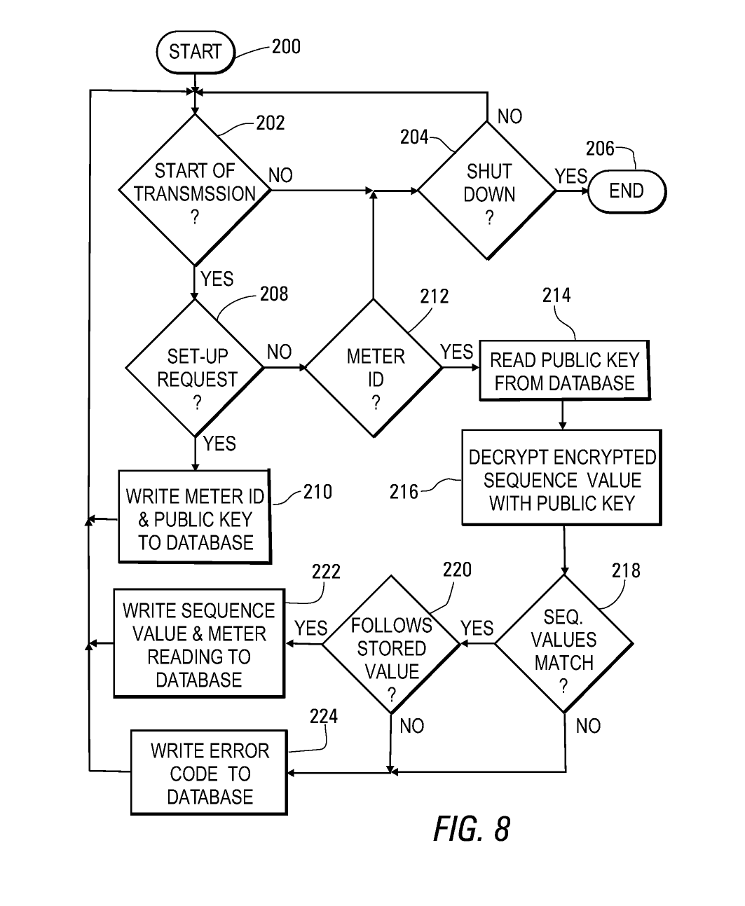

FIG. 8 is a flow chart of processes occurring within the AMR system 30 under control of a routine executing within the processor 34 in accordance with the second embodiment of the invention. After this routine starts in step 200, the AMR system 30 proceeds to step 202 to wait for the start of a transmission from a meter 12, as described above in reference to FIG. 7. Preferably this routine operates almost continuously within the AMR system 30, allowing a meter 12 to access the system 30 at any time. However, if it is determined in step 202 that a such a transmission is not occurring, a further determination is made in step 204 of whether the system is to be shut down for maintenance or modification. If it is to be shut down, the routine ends in step 206; otherwise, the system returns to step 202 to again determine when a transmission is being started.

After a determination is made in step 202 that a transmission has begun, a further determination is made in step 208 of whether the transmission includes a set-up request for registration. If it does, the system 30 proceeds to step 210 to write the meter identifier and public key, transmitted in steps 166 and 168 as described above in reference to FIG. 7, to the database 42, forming a new data record. If it is determined in step 208 that the transmission does not include a set-up request, a further determination is made in step 212 of whether the transmission includes a meter identifier stored within the database 42. If it does not, the system proceeds to step 204 to determine if the system is to be shut down and to wait for the next transmission.

If the transmission does contain a meter identifier, the public key of the meter associated with the identifier is read from the database 42 in step 214. It is understood that the transmission of such an identifier has occurred in step 193 as described above in reference to FIG. 1, as a concatenated value additionally including the sequence generator value from the meter in both an unencrypted form and in a form concatenated with, a value providing a meter reading indicating usage of the utility product and encrypted with the private key of the meter. Thus in step 216, the encrypted portion of this value is decrypted using the public key read in step 214. Then, in step 218, a determination is made of whether the decrypted sequence generator value generated in step 216 matches the unencrypted version of the sequence generator value. If these values match, a further determination is made in step 220 of whether the sequence generator value follows a sequence generator value received the during the last communication from this particular meter 12, which has been stored in the database 42 within the data record associated with the meter 12. If it follows the stored value in the sequence, the new sequence generator value and the meter reading are written to the database 42 in step 222. If the sequence generator values do not match, as determined in step 218, or if the sequence generator value does not follow the previously stored sequence generator value, as determined in step 220, an error code is written to the data record associated with the meter 12 within the database 42 in step 224.

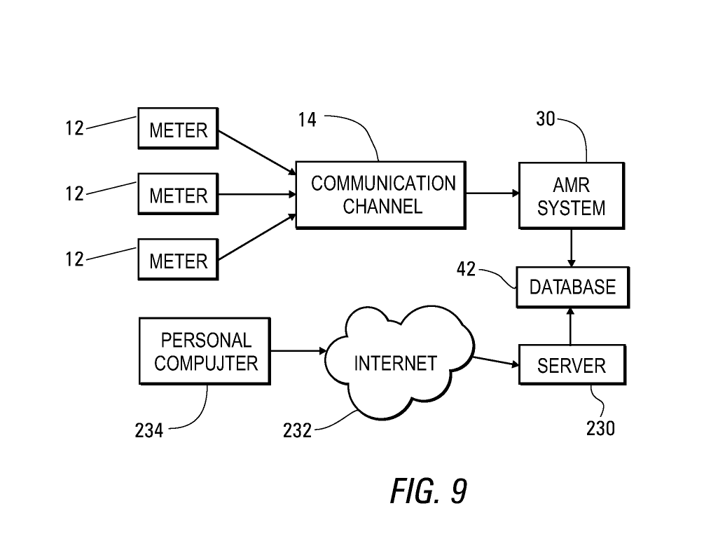

FIG. 9 is a block diagram of a system configured to provide for registration of meters 12 with the AMR system 30 in accordance with a third embodiment of the invention, with a server computer 230 connected to the Internet 232 and having access to the database 42 being added to the system of FIG. 1.

In accordance with the third embodiment of the invention, during the process of registering a meter 12 with the AMR system 30, the technician installing the meter 12 contacts the server computer 230 using a browser within a personal computer 234 through the Internet 232. Part of the connection between the personal computer 234 and the Internet 232 may be made through a wireless link. The personal computer 234 is used to supply information associated with the meter 12 being registered, such as the name and address of the individual or organization to be billed for utility product usage measured by the meter 12. The personal computer 12 may also be used to receive information regarding the registration process, such as an indication that the registration process has been successfully completed.

For example, if the communication network 14 is a one-way network, providing for communication from the meters 12 to the AMR system 30, the process of registering a meter 12 proceeds as described above in reference to FIGS. 7 and 8. Then, the technician installing the meter 12 contacts the server computer 230 through the Internet 232 to provide the additional information needed for billing. In this communication, he provides the meter identifier transmitted by the meter 12 in step 166. This meter identifier is used to associate the information provided through the Internet with the data record established within the database 42, with the server computer 230 then writing data received from the personal computer 234 to this particular data record within the database 42. The successful completion of recording this information is then used to determine, within the server 230, that the registration process is completed, with an acknowledgement of successful completion being transmitted over the Internet 232 from the server 230 to the personal computer 234.

While the invention has been described in its preferred forms or embodiments with some degree of particularity, it is understood that this description has been given only by way of example, and that many variations may be made without departing from the spirit and scope of the invention, as defined by the appended claims.

What is claimed is:

1. A meter for measuring usage of a utility product and for transmitting data representing said usage to be recorded at a remote location, wherein said meter comprises:
data storage storing a private cryptographic key of said meter:
a communication adapter for data communication over a communication network; and
a microprocessor accessing said data storage and programmed to encrypt a message with said private cryptographic key and to transmit said message encrypted with said private cryptographic key, wherein said message includes an alphanumeric value and a data value representing a measured usage of said utility product over said communication network.

2. The meter of claim 1, wherein
said meter additionally comprises an emitter generating a pulsed signal with said measured usage of said utility product,
said data storage additionally stores said value representing said measured usage of said utility product, and
said microprocessor is additionally programmed to receive said pulsed signal, to update said value stored within said data storage with pulses within said pulsed signal, and to read said value from said data storage for transmission of said value over said communication network.

3. The meter of claim 1, wherein
said meter additionally includes a circuit producing a tamper evident signal in response to detecting tampering with said meter by disconnecting said meter from said utility product or by opening a cover of said meter, and
said microprocessor is additionally programmed to prevent further transmission of utility usage data in response to said tamper evident signal.

4. The meter of claim 3, wherein further transmission of utility usage data is prevented by erasing said private cryptographic key stored within said data storage.

5. The meter of claim 1, wherein said microprocessor is additionally programmed to receive a random value transmitted over said communication network as said alphanumeric value to be encrypted.

6. The meter of claim 1, wherein said microprocessor is additionally programmed to determine whether a call received over said communication network has come from said central computer system.

7. The system of claim 1, wherein said microprocessor is additionally programmed to generate an ordered sequence of values for use as said alphanumeric value, and to transmit, on a periodic basis, to said central computer system, a next value from said ordered sequence of values, in an unencrypted form and as combined with said data value representing said measured usage of said utility product, and encrypted with said private cryptographic key.

8. A method for transmitting data regarding usage of a utility product to a remote location and for storing said data in said remote location, wherein said method comprises:
a) generating said data within a meter in response to usage of said utility product;
b) storing said data within said meter;
c) encrypting a message with a private cryptographic key stored within said meter, wherein said message includes an alphanumeric value and a data value representing utility usage derived from said data stored within said meter;
d) transmitting said message encrypted with said private cryptographic key over a communication network to a remote central computer system;
e) decrypting said message encrypted with said private cryptographic key within said remote central computer using a public cryptographic key of said meter stored within a database accessed by said remote central computer, wherein said public cryptographic key decrypts information encrypted with said private cryptographic key; and
f) comparing said alphanumeric value decrypted in step e) with an unencrypted version of said alphanumeric value.

9. The method of claim 8, wherein step a) is preceded by:
g) transmitting said public cryptographic key of said meter, along with an identifier of said meter, from said meter to said central computer over said communication network; and
h) writing said identifier of said meter and said public cryptographic key of said meter within a data record in said database accessed by said central computer.

10. The method of claim 8, wherein
step a) is preceded by following steps i) through k):
i) generating a random value in said central computer and storing said random value as said unencrypted version of said alphanumeric value;
j) initiating a call over said communication network from said central computer to said meter; and
k) transmitting said random value as said alphanumeric value over said communication network from said central computer to said meter, and
step e) is followed by:
l) storing said utility usage data transmitted from said meter in step d) in response to a determination in step f) that said alphanumeric value decrypted in step e) matches said unencrypted version of said alphanumeric value.

11. The method of claim 10, wherein
step l) is preceded by following steps m) through n):
m) transmitting said public cryptographic key of said meter, along with an identifier of said meter, from said meter to said central computer over said communication network; and
n) writing said identifier of said meter and said public cryptographic key of said meter within a data record in said database accessed by said central computer, and
in step l) said utility usage data is stored in said data record in said database accessed by said central computer.

12. The method of claim 8, wherein
step a) is preceded by following steps o) through p):
o) generating and storing a sequential value to be encrypted as said alphanumeric value within a predetermined sequence of sequential values within said meter, and
p) initiating a call over said communication network from said meter to said central computer,
in step d), said sequential value is additionally transmitted in an unencrypted form, along with said message encrypted with said private cryptographic key, and
step f) is followed by following steps q) through r):
q) determining in said central computer system whether said alphanumeric value additionally transmitted in an unencrypted form in step d) follows a alphanumeric value additionally transmitted by said meter in said predetermined sequence of alphanumeric values, and
r) storing said utility usage data transmitted from said meter in step d) in response to a determination in step f) that said message decrypted in step e) matches said unencrypted version of said message together with a determination in step o) that said alphanumeric value additionally transmitted in an unencrypted form in step d) follows a alphanumeric value additionally transmitted by said meter in said predetermined sequence of alphanumeric values.

13. The method of claim 12, wherein
step o) is preceded by following steps s) through t):
s) transmitting said public cryptographic key of said meter, along with an identifier of said meter, from said meter to said central computer over said communication network; and
t) writing said identifier of said meter and said public cryptographic key of said meter within a data record in said database accessed by said central computer, and
in step r) said utility usage data is stored, along with said alphanumeric value additionally transmitted by said meter in said data record in said database accessed by said central computer.

14. A method for transmitting data regarding usage of a utility product to a remote location, wherein said method comprises:
a) generating said data within a meter in response to usage of said utility product;
b) storing said data within said meter;
c) encrypting a message with a private cryptographic key stored within said meter, wherein said message includes an alphanumeric value and a data value representing utility usage derived from said data stored within said meter; and
d) transmitting said message encrypted with said private cryptographic key over a communication network to a remote central computer system.

15. The method of claim 14, wherein step a) is preceded by transmitting said public cryptographic key of said meter, along with an identifier of said meter, from said meter to said central computer over said communication network.

16. The method of claim 14, wherein step a) is preceded by:
e) receiving said alphanumeric value in a call over said communication network initiated by said central computer system.

17. The method of claim 16, wherein step e) is preceded by transmitting said public cryptographic key of said meter, along with an identifier of said meter, from said meter to said central computer over said communication network.

18. The method of claim 14, wherein
step a) is preceded by following steps f) through g):
f) generating and storing a value to be encrypted as said alphanumeric value within a predetermined sequence of values in said meter, and
g) initiating a transmission over said communication network from said meter to said central computer, and
in step d), said alphanumeric value is additionally transmitted in an unencrypted form, along with said message encrypted with said private cryptographic key.

19. The method of claim 18, wherein step f) is preceded by transmitting said public cryptographic key of said meter, along with an identifier of said meter, from said meter to said central computer over said communication network.

20. A computer readable medium having computer readable program code embodied therein causing a microprocessor within a meter measuring usage of a utility product to perform a method for transmitting data regarding usage of said utility product to a remote location, wherein said method comprises:
a) generating said data within a meter in response to usage of said utility product;
b) storing said data within said meter;
c) encrypting a message with a private cryptographic key stored within said meter, wherein said message includes an alphanumeric value and a data value representing utility usage derived from said data stored within said meter; and
d) transmitting said message encrypted with said private cryptographic key over a communication network to a remote central computer system.

21. The computer readable medium of claim 20, wherein step a) is preceded by transmitting said public cryptographic key of said meter, along with an identifier of said meter, from said meter to said central computer over said communication network.

22. The computer readable medium of claim 20, wherein step a) is preceded by:
e) receiving said alphanumeric value in a call over said communication network initiated by said central computer system.

23. The computer readable medium of claim 22, wherein step e) is preceded by transmitting said public cryptographic key of said meter, along with an identifier of said meter, from said meter to said central computer over said communication network.

24. The computer readable medium of claim 20, wherein
step a) is preceded by following steps f) through g):
f) generating and storing a value to be encrypted as said alphanumeric value within a predetermined sequence of values in said meter, and
g) initiating a transmission over said communication network from said meter to said central computer, and
in step d), said alphanumeric value is additionally transmitted in an unencrypted form, along with said message encrypted with said private cryptographic key.

25. The computer readable medium of claim 24, wherein step f) is preceded by transmitting said public cryptographic key of said meter, along with an identifier of said meter, from said meter to said central computer over said communication network.

26. A computer data signal embodied in a carrier wave comprising program code causing a microprocessor within a meter measuring usage of a utility product to perform a method for transmitting data regarding usage of said utility product to a remote location, wherein said method comprises:
a) generating said data within a meter in response to usage of said utility product;
b) storing said data within said meter;
c) encrypting a message with a private cryptographic key stored within said meter, wherein said message includes an alphanumeric value and a data value representing utility usage derived from said data stored within said meter; and
d) transmitting said message encrypted with said private cryptographic key over a communication network to a remote central computer system.

27. The computer data signal of claim 26, wherein step a) is preceded by transmitting said public cryptographic key of said meter, along with an identifier of said meter, from said meter to said central computer over said communication network.

28. The computer data signal of claim 27, wherein step a) is preceded by:
e) receiving said alphanumeric value in a call over said communication network initiated by said central computer system.

29. The computer data signal of claim 28, wherein step e) is preceded by transmitting said public cryptographic key of said meter, along with an identifier of said meter, from said meter to said central computer over said communication network.

30. The computer data signal of claim 26, wherein
step a) is preceded by following steps f) through g):
f) generating and storing a value to be encrypted as said alphanumeric value within a predetermined sequence of values in said meter, and
g) initiating a transmission over said communication network from said meter to said central computer, and
in step d), said alphanumeric value is additionally transmitted in an unencrypted form, along with said message encrypted with said private cryptographic key.

31. The computer data signal of claim 30, wherein step f) is preceded by transmitting said public cryptographic key of said meter, along with an identifier of said meter, from said meter to said central computer over said communication network.
